(19) United States
(12) Patent Application Publication
(10) Pub. No.: US 2026/0247073 A1
(43) Pub. Date: Aug. 20, 2026

(54) OPTIMAL ROOM CORRECTION BASED ON IN-EAR BINAURAL MEASUREMENTS

(71) Applicant: BACCH LABORATORIES, INC., Gainesville, FL (US)

(72) Inventor: Edgar Y. Choueiri, PRINCETON, NJ (US)

(21) Appl. No.: 19/056,420

(22) Filed: Feb. 18, 2025

Related U.S. Application Data
(60) Provisional application No. 63/615,093, filed on Dec. 27, 2023.

(51) Int. Cl. H04R 3/04; H04R 3/12

(52) U.S. Cl. CPC H04R 3/04; H04R 3/12

(57) ABSTRACT

Systems and methods are provided for correcting the frequency response of speakers as heard by an individual listener in a given room. Room correction filters can be derived from one or more in-ear binaural microphone measurements, which work well for the playback of both binaural and non-binaural recordings. A novel binaural compensation process of the measured transfer function can be used, which compensates for the particular spectral coloration at the entrance of the ear canals of the listener caused by the particular location of the playback speaker.

### CROSS-REFERENCE TO A RELATED APPLICATION

This application claims the benefit of U.S. Provisional Application Ser. No. 63/615,093, filed Dec. 27, 2023, which is incorporated herein by reference in its entirety.

### BACKGROUND

Existing room correction (RC) methods, including available commercial RC methods, use a regular microphone in the free field to make an acoustic measurement (or a set of such measurements at various locations around the listening position, which are then averaged) of the sound from loudspeakers, which are used to design an RC filter that compensates for at least some of the non-idealities of the sound reproduced in that room. In the related art, it is generally thought that for the playback of non-binaural recordings (which is the vast majority of existing commercial recordings), only free field RC is appropriate as a binaural RC filter (i.e., one done based on measurement with in-ear microphones). This can add coloration due to the inverted head-related transfer function (HRTF) of the listener because the original non-binaural recording does not contain an HRTF effects.

### BRIEF SUMMARY

Embodiments of the subject invention provide novel and advantageous systems and methods for correcting the frequency response of speakers (e.g., loudspeakers) as heard by an individual listener in a given room. Room correction (RC) filters can be derived from one or more in-ear binaural microphone measurements, which work well for the playback of both binaural and non-binaural recordings. A novel binaural compensation process of the measured transfer function can be used, which compensates for the particular spectral coloration at the entrance of the ear canals of the listener(s) caused by the particular location of the playback speaker (e.g., loudspeaker). Because that coloration is associated with the spectral cues of a source located at that particular speaker location and not necessarily the location of the original recorded source, this spectral coloration can artificially detract from the correct perception of the interaural level difference (ILD) spatial cue and/or the interaural time difference (ITD) spatial cue in non-binaural stereo recording. This spectral coloration can also artificially detract from the spectral cues in binaural recordings, and it is not removed by related art RC techniques, which aim to flatten (or correct) the response of the speaker in free field.

In an embodiment, a system for correcting a frequency response of at least one speaker (e.g., loudspeaker, such as two speakers (e.g., two loudspeakers)) as heard by an individual listener in a room can comprise a processor and a machine-readable medium in operable communication with the processor and having instructions stored thereon that, when executed by the processor, perform the following steps: i) acquiring a measurement of a binaural room impulse response using an in-ear microphone to obtain two ipsilateral impulse responses comprising a left ipsilateral impulse responses for a left ear portion of the in-ear microphone and a right ipsilateral impulse response for a right ear portion of the in-ear microphone; ii) limiting the two ipsilateral impulse responses with a first time window (e.g., at least 35 milliseconds (ms)) that is configured to include effects of sound reflections that need to be reflected, give two windowed impulse responses; iii) extracting a direct part of the two windowed impulse responses using a second time window (e.g., 5 ms or about 5 ms) with a length that is configured to include a direct sound, to give two direct part impulse responses (IR1 and IR2); iv) calculating a frequency response corresponding to each of the two direct part impulse responses (IR1 and IR2) by taking their respective Fourier transforms, to give two intermediate frequency responses comprising a first intermediate frequency response (FR1) and a second intermediate frequency response (FR2); v) constructing a composite spectrum with a low-frequency part from the first intermediate frequency response and a high-frequency part from the second intermediate frequency response, to give two composite intermediate frequency responses comprising a first composite intermediate frequency response (CFR1) and a second composite intermediate frequency response (CFR2), wherein the low-frequency part is less than a cutoff frequency (e.g., in a range of from 800 Hertz (Hz) to 2000 Hz) and the high-frequency part is greater than or equal to the cutoff frequency; vi) applying diffuse field equalization (DFEq) to the two composite intermediate frequency responses (CFR1 and CFR2); vii-a) locating a first pinna notch (PNF1) that is a frequency of a first main notch in the first composite intermediate frequency response (CFR1) that is a range of from 5 kilohertz (kHz) to 10 kHz; vii-b) locating a second pinna notch (PNF2) that is a frequency of a first main notch in the second composite intermediate frequency response (CFR2) that is a range of from 5 kHz to 10 kHz; viii-a) splitting the first composite intermediate frequency response (CFR1) into a first quasi-free field band, a first low-order pinna band, and a first high-order pinna band, wherein the first quasi-free field band is between a first predetermined low limit frequency (LF1) and a first predetermined middle limit frequency (MF1) that is higher than the first predetermined low limit frequency (LF1) and lower than the first pinna notch (PNF1), wherein the first low-order pinna band is between the first predetermined middle limit frequency (MF1) and the first pinna notch (PNF1), and wherein the first high-order pinna band is between the first pinna notch (PNF1) and a first predetermined high limit frequency (HF1) (e.g., a desired high-frequency limit for the correction, or the Nyquist frequency) that is higher than the first pinna notch (PNF1); viii-b) splitting the second composite intermediate frequency response (CFR2) into a second quasi-free field band, a second low-order pinna band, and a second high-order pinna band, wherein the second quasi-free field band is between a second predetermined low limit frequency (LF2) and a second predetermined middle limit frequency (MF2) that is higher than the second predetermined low limit frequency (LF2) and lower than the second pinna notch (PNF2), wherein the second low-order pinna band is between the second predetermined middle limit frequency (MF2) and the second pinna notch (PNF2), and wherein the second high-order pinna band is between the second pinna notch (PNF2) and a second predetermined high limit frequency (HF2) (e.g., a desired high-frequency limit for the correction, or the Nyquist frequency) that is higher than the second pinna notch (PNF2); ix) determining (e.g., estimating or calculating) a measure of the spectral entropy for each of the first quasi-free field band, the first low-order pinna band, the first high-order pinna band, the second quasi-free field band, the second low-order pinna band, and the second high-order pinna band, to give a first quasi-free field spectral entropy measure (QFF-SE1), a first low-order pinna spectral entropy measure (LOP-SE1), a first high-order pinna spectral entropy measure (HOP-SE1), a second quasi-free field spectral entropy measure (QFF-SE1), a second low-order pinna spectral entropy measure (LOP-SE2), and a second high-order pinna spectral entropy measure (HOP-SE2); x-a) making three copies of the first composite intermediate frequency response (CFR1), and using a complex spectral smoothing method to smooth each of the three copies of the first composite intermediate frequency response, to give three first smoothed spectra respectively corresponding to the three copies of the first composite intermediate frequency response; x-b) making three copies of the second composite intermediate frequency response (CFR2), and using the complex spectral smoothing method to smooth each of the three copies of the second composite intermediate frequency response, to give three second smoothed spectra respectively corresponding to the three copies of the second composite intermediate frequency response; xi) inverting each of the three first smoothed spectra and the three second smoothed spectra, to give three inverted first spectra and three inverted second spectra respectively corresponding to the three first smoothed spectra and the three second smoothed spectra; xii-a) constructing a final first composite spectrum by smoothly joining a first segment, a second segment, and a third segment respectively taken from the three inverted first spectra; xii-b) constructing a final second composite spectrum by smoothly joining a fourth segment, a fifth segment, and a sixth segment respectively taken from the three inverted second spectra; and xiii) deriving a finite response filter from the final first composite spectrum and the final second composite spectrum, wherein the finite response filter is configured to be convolved with input audio of the at least one speaker to correct the frequency response of the at least one speaker. LF1 can be the same as, or different from, LF2; MF1 can be the same as, or different from, MF2; and HF1 can be the same as, or different from, HF2.

The three copies of the first composite intermediate frequency response (CFR1) can comprise a first quasi-free field composite intermediate frequency response (QFF-CFR1), a first low-order pinna composite intermediate frequency response (LOP-CFR1), and a first high-order pinna composite intermediate frequency response (HOP-CFR1). Using the complex spectral smoothing method to smooth each of the three copies of the first composite intermediate frequency response in step x-a) can comprise smoothing the first quasi-free field composite intermediate frequency response (QFF-CFR1) based on a first smoothing degree that is proportional to the first quasi-free field spectral entropy measure (QFF-SE1), smoothing the first low-order pinna composite intermediate frequency response (LOP-CFR1) based on a second smoothing degree that is proportional to the first low-order pinna spectral entropy measure (LOP-SE1), and smoothing the first high-order pinna composite intermediate frequency response (HOP-CFR1) based on a third smoothing degree that is proportional to the first high-order pinna spectral entropy measure (HOP-SE1). The three copies of the second composite intermediate frequency response (CFR2) can comprise a second quasi-free field composite intermediate frequency response (QFF-CFR2), a second low-order pinna composite intermediate frequency response (LOP-CFR2), and a second high-order pinna composite intermediate frequency response (HOP-CFR2). Using the complex spectral smoothing method to smooth each of the three copies of the second composite intermediate frequency response in step x-b) can comprise smoothing the second quasi-free field composite intermediate frequency response (QFF-CFR2) based on a fourth smoothing degree that is proportional to the second quasi-free field spectral entropy measure (QFF-SE2), smoothing the second low-order pinna composite intermediate frequency response (LOP-CFR2) based on a fifth smoothing degree that is proportional to the second low-order pinna spectral entropy measure (LOP-SE2), and smoothing the second high-order pinna composite intermediate frequency response (HOP-CFR2) based on a sixth smoothing degree that is proportional to the second high-order pinna spectral entropy measure (HOP-SE2). The three inverted first spectra can comprise a first inverted quasi-free field spectrum (QFF-InvSCFR1), a first inverted low-order pinna spectrum (LOP-InvSCFR1), and a first inverted high-order pinna spectrum (HOP-InvSCFR1). The three inverted second spectra can comprise a second inverted quasi-free field spectrum (QFF-InvSCFR2), a second inverted low-order pinna spectrum (LOP-InvSCFR2), and a second inverted high-order pinna spectrum (HOP-InvSCFR2). In step xii-a), the first segment can be taken from the first inverted quasi-free field spectrum (QFF-InvSCFR1) between the first predetermined low limit frequency (LF1) and the first predetermined middle limit frequency (MF2), the second segment can be taken from the first inverted low-order pinna spectrum (LOP-InvSCFR1) between the first predetermined middle limit frequency (MF1) and the first pinna notch (PNF1), and the third segment can be taken from the first inverted high-order pinna spectrum (HOP-InvSCFR1) between the first pinna notch (PNF1) and the first predetermined high limit frequency (HF1). In step xii-b), the fourth segment can be taken from the second inverted quasi-free field spectrum (QFF-InvSCFR2) between the second predetermined low limit frequency (LF1) and the second predetermined middle limit frequency (MF2), the fifth segment can be taken from the second inverted low-order pinna spectrum (LOP-InvSCFR2) between the second predetermined middle limit frequency (MF2) and the second pinna notch (PNF2), and the sixth segment can be taken from the second inverted high-order pinna spectrum (HOP-InvSCFR2) between the second pinna notch (PNF2) and the second predetermined high limit frequency (HF2).

Step ix) can comprise using the Shannon entropy formula to determine the measure of the spectral entropy for each of the first quasi-free field band, the first low-order pinna band, the first high-order pinna band, the second quasi-free field band, the second low-order pinna band, and the second high-order pinna band. Step xiii) can comprise: using the Hilbert transform on the final first composite spectrum to calculate an imaginary part of a spectrum of a minimum phase filter whose real part is that of the final first composite spectrum, and then using the inverse Fourier transform to get a first finite impulse response (FIR) of the finite response filter; using the Hilbert transform on the final second composite spectrum to calculate an imaginary part of a spectrum of a minimum phase filter whose real part is that of the final second composite spectrum, and then using the inverse Fourier transform to get a second FIR of the finite response filter; and/or combining the first FIR and the second FIR to obtain the finite response filter. Step i) can comprise: performing playback of exponential sine sweeps from the at least one speaker; recording sound at respective entrances of ear canals of the individual listener; and/or then using at least one deconvolution technique to deconvolve an impulse response of the sound in order to acquire the measurement of the binaural room impulse response. The first predetermined low limit frequency (LF1) and/or the second predetermined low limit frequency (LF2) can be, for example, below 500 Hz (e.g., less than 100 Hz, such as 20 Hz or less). The first predetermined middle limit frequency (MF1) and/or the second predetermined middle limit frequency (MF2) can be in a range of, for example, from 700 Hz to 1000 Hz. Step vi) can comprise, for example, multiplying each of the two composite intermediate frequency responses by an inverse diffuse field response obtained by averaging a large number (e.g., at least 10, such as at least 20, at least 30, or at least 40) measurements on human heads. The instructions when executed can further perform the following step: xiv) providing the finite response filter to a source of the input audio of the at least one speaker such that the finite response filter is convolved with the input audio, thereby correcting the frequency response of the at least one speaker. The system can further comprise a display in operable communication with the processor and/or the machine-readable medium. The instructions when executed can further perform the following step: xv) displaying, on the display, any intermediate or final result of any of steps i)-xiv).

In another embodiment, a method for correcting a frequency response of at least one speaker (e.g., loudspeaker, such as two speakers (e.g., two loudspeakers)) as heard by an individual listener in a room can comprise performing (e.g., by a processor) steps i)-vi), vii-a), vii-b), viii-a), viii-b), ix), x-a), x-b), xi), xii-a), xii-b), and xiii) as listed above. The method can further comprise performing (e.g., by the processor) steps xiv) and/or xv) as listed above (where, for step xv), the display is in operable communication with the processor). The method can include any or all of the features discussed in the previous three paragraphs.

### BRIEF DESCRIPTION OF DRAWINGS

FIG. 1 shows a flow chart of a system/method for correcting the frequency response of speakers, according to an embodiment of the subject invention.

FIG. 2 shows a plot of amplitude (in decibels (dB)) versus frequency (in Hertz (Hz)), showing measured diffuse field response. The thickest (green) curve represents the average of 40 human head measurements. The dashed (red) curve is for KEMAR (a head and torso simulator used for testing hearing aids, headphones, and other devices); the thinner (purple) curve with the lowest amplitude values around 2000 Hz to 7000 Hz is for KU100 (a dummy head binaural stereo microphone); and the other thin (blue) lines are for all human (see also Armstrong et al., A Perceptual Evaluation of Individual and Non-Individual HRTFs: A Case Study of the SADIE II Database, Appl. Sci. 2018, 8, 2029,doi:10.3390/app8112029; which is hereby incorporated by reference herein in its entirety).

### DETAILED DESCRIPTION

Embodiments of the subject invention provide novel and advantageous systems and methods for correcting the frequency response of speakers (e.g., loudspeakers) as heard by an individual listener in a given room. Room correction (RC) filters can be derived from one or more in-ear binaural microphone measurements, which work well for the playback of both binaural and non-binaural recordings. A novel binaural compensation process of the measured transfer function can be used, which compensates for the particular spectral coloration at the entrance of the ear canals of the listener(s) caused by the particular location of the playback speaker (e.g., loudspeaker). Because that coloration is associated with the spectral cues of a source located at that particular speaker location and not necessarily the location of the original recorded source, this spectral coloration can artificially detract from the correct perception of the interaural level difference (ILD) spatial cue and/or the interaural time difference (ITD) spatial cue in non-binaural stereo recording. This spectral coloration can also artificially detract from the spectral cues in binaural recordings, and it is not removed by related art RC techniques, which aim to flatten (or correct) the response of the speaker in free field.

Embodiments of the subject invention, which can be referred to herein as Binaurally-Compensated Optimal Room Correction (BC-ORC), provide several advantages. Because the acoustic measurement can be done at the ear(s) of the listener(s), the listener's head can be tracked (during measurement and/or playback) using existing head tracking techniques, allowing RC at playback to always match the corresponding head location. This obviates the need to make time-consuming measurements at multiple spatial points surrounding the anticipated head location (and then averaging these measurements), and thus greatly enhances the speed of making RC filters, while also allowing for implementation of dynamically adjusted optimal RC (ORC) filters as a function of tracked head position. This significantly enhances the accuracy of RC. Also, Because the BC-ORC can be based on in-ear binaural measurements, it can be easily integrated with other technologies that require in-ear binaural measurements, such as custom-made (individualized) crosstalk cancellation (XTC), where both types (RC and XTC) of filters can be derived from the same in-ear measurements. Other advantages are discussed in the previous paragraph.

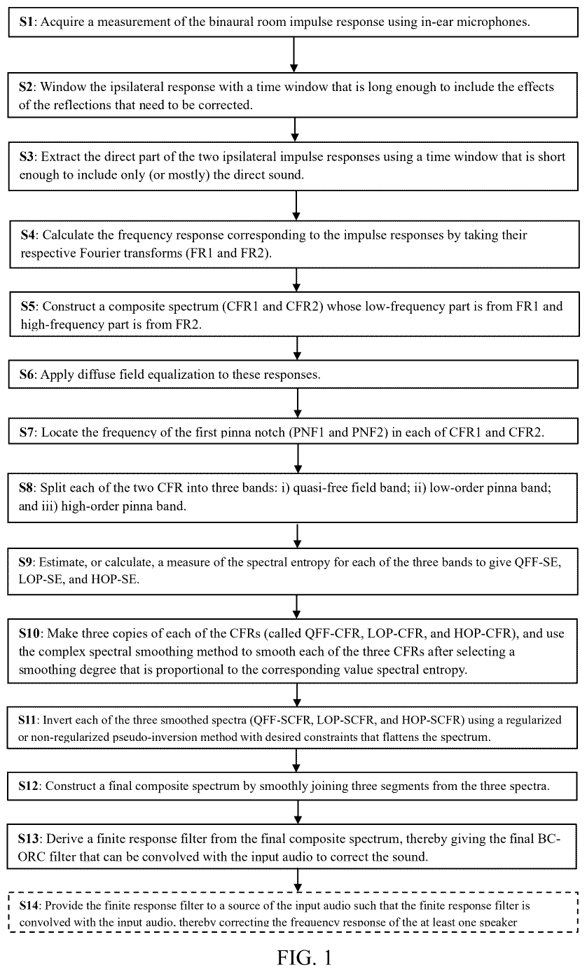

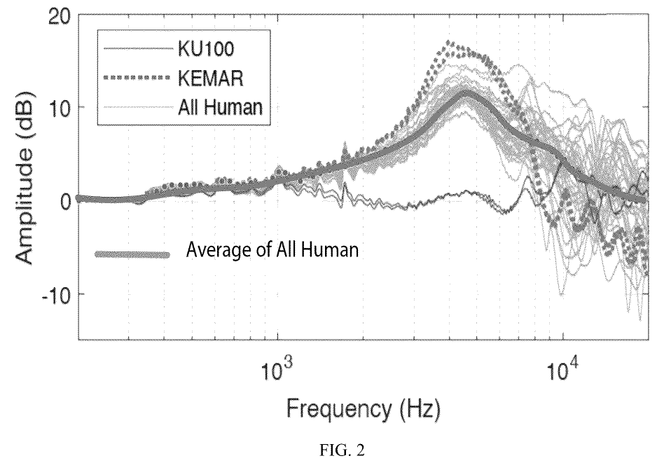

FIG. 1 shows a flow chart of a system/method for correcting the frequency response of speakers, according to an embodiment of the subject invention. Referring to FIG. 1, the BC-ORC can include some or all of the following steps and/or components.
Acquire (e.g., record) (S1) a measurement of the binaural room impulse response using in-ear microphones. This can be done by playback of exponential sine sweeps from the speaker(s) (e.g., loudspeakers), recording the sound at the entrance of the ear canals, and then using one or more deconvolution techniques (e.g., standard deconvolution techniques) to deconvolve the impulse response (or by equivalent methods).
Window (i.e., limit) (S2) the ipsilateral response with a time window that is long enough to include the effects of the reflections (early and/or late) that need to be corrected (e.g., 35 milliseconds (ms) and longer). This impulse response can be called IR1L and IR1R.
Extract (S3) the direct part of the two ipsilateral (left speaker-left ear; and right speaker-right ear) impulse responses using a time window that is short enough to include only (or mostly) the direct sound (e.g., 5 ms or about 5 ms). This impulse response can be called IR1 and IR2 (there will be one such impulse response for each ear, IR2L and IR1R).
Calculate (S4) the frequency response (decibels (dB) versus Hertz (Hz)) corresponding to IR1 and IR2 by taking their respective Fourier transforms, which can be called FR1 and FR2 (there will be a left and right ear part for each: FR1L, FR1R, FR2L, and FR2R).
Construct (S5) a composite spectrum whose low-frequency part (less than FreqA, where FreqA is, e.g., in a range of from 800 Hz to 2000 Hz) is from FR1 and high-frequency part (greater than equal to FreqA) is from FR2. These can be referred to as CFR1 and CFR2, respectively.
Apply (S6) diffuse field equalization (DFEq) to these responses by, for instance, multiplying CFR1 and CFR2 by either the inverse diffuse field response of the listener's head, if it is available (that is rarely the case as that requires measuring and averaging the entire head-related transfer function (HRTF) of that head or measuring its diffuse filed response directly in a reverb chamber) or the inverse diffuse field response obtained by averaging a large number of measurements of human heads. An example of such a diffuse filed response is the green curve added to FIG. 2, which represents the averaging of the diffuse field measurements of 40 human heads (see also Armstrong et al., supra.). Such diffuse field equalization is essential to ensure that the strong first-order binaural spectral features of FR1 and FR2 are compensated for.
Locate (S7) the frequency of the first “pinna notch” in CFR1 and CFR2, defined as the frequency of the first main notch in the frequency response between 5 kilohertz (kHz) and 10 kHz. These pinna notch frequencies can be referred to as PNF1 and PNF2.
Split (S8) each of the two CFR into three bands: i) quasi-free field band, between LF (e.g., a desired high-frequency limit for the correction, such as 20 Hz) and MF (where MF corresponds to the frequency above which the effects of the human head on sound become important, for example, somewhere in a range of from 700 Hz to 1000 Hz); ii) low-order pinna band, between MF and PNF; and iii) high-order pinna band, between PNF and the high-frequency limit (e.g., a desired high-frequency limit for the correction, or the Nyquist frequency).
Estimate, or calculate, (S9) a measure of the spectral entropy for each of the three bands. These three values can be referred to as QFF-SE, LOP-SE, and HOP-SE. One such measure can be calculated from the well-known Shannon entropy formula: H=−Σp(f)log2 p(f), where p(f)=P(f)/Σf′P(f′) is the normalized power at frequency f, P(f) is the power spectrum and the denominator (Σf′P(f′)) is the sum of power values over all frequencies f′. A higher Spectral Entropy value indicates a more uniform or random distribution of power across frequencies; conversely, a lower value indicates a more concentrated or less random power distribution).
Make three copies (S10) of each of the CFR and call them QFF-CFR, LOP-CFR, and HOP-CFR. Then, use the complex spectral smoothing method (which preserves log-frequency symmetry) to smooth each of the three CFRs after selecting a smoothing degree that is proportional to the corresponding value spectral entropy (QFF-SE, LOP-SE, and HOP-SE) (see also Tylka, Boren, and Choueiri, A Generalized Method for Fractional-Octave Smoothing of Transfer Functions that Preserves Log-Frequency Symmetry, Journal of Audio engineering Society, Volume 65 Issue 3 pp. 239-245, March 2017; which is hereby incorporated by reference herein in its entirety). The higher the spectral entropy, the higher is the degree of complex smoothing. The resulting smoothed spectra can be referred to as QFF-SCFR, LOP-SCFR, and HOP-SCFR.
Invert (S11) each of the three smoothed spectra (QFF-SCFR, LOP-SCFR, and HOP-SCFR) using a regularized or non-regularized pseudo-inversion method with desired constraints (such as a maximum allowable boost of x dB) that flattens the spectrum (or matches a desired target curve). The resulting inverted spectra can be referred to as QFF-InvSCFR, LOP-InvSCFR, and HOP-InvSCFR.
Construct (S12) a final composite spectrum by smoothly joining three segments from the three spectra such that the first segment is taken from QFF-InvSCFR between frequencies LF and MF, the second is taken from LOP-InvSCFR between frequencies MF and PNF, and the last is taken from HOP-InvSCFR between frequencies PNF and HF.
Derive (S13) a finite response filter from the final composite spectrum. This can be done by, for example, using the Hilbert transform to calculate the imaginary part of the spectrum of a minimum phase filter whose real part is that of the original spectrum, and then using the inverse Fourier transform to get the filter's finite impulse response (FIR). This is the final BC-ORC filter that is convolved with the input audio to correct the sound.

The finite response filter can be provided (S14) to one or more sources of the input audio of the speaker(s), and the finite response filter can be convolved with the input audio, thereby correcting the frequency response of the speaker(s).

In some embodiments, the BC-ORC can be implemented at least in part via one or more software modules. It has been programmed, tested thoroughly, evaluated against other RC methods using both objective and subjective measures, and outperformed the other RC methods.

Embodiments of the subject invention provide a focused technical solution to the focused technical problem of how to correct the frequency response of one or more speakers (particularly as heard by an individual listener in a room). The solution is provided by using a novel binaural compensation process of the measured transfer function, which compensates for the particular spectral coloration at the entrance of the ear canals of the listener(s) caused by the particular location of the speaker(s) (see also FIG. 1). The derived finite response filter can be used in many practical applications, including but not limited to: providing it to one or more sources of the input audio of the speaker(s), such that the finite response filter can be convolved with the input audio, thereby correcting the frequency response of the speaker(s); or providing it to scientists and/or engineers working on RC, so that it can be used to produce better quality sound in the future.

The methods and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that are capable of storing computer-readable information/data. Computer-readable media should not be construed or interpreted to include any propagating signals. A computer-readable medium of embodiments of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

When the term module is used herein, it can refer to software and/or one or more algorithms to perform the function of the module; alternatively, the term module can refer to a physical device configured to perform the function of the module (e.g., by having software and/or one or more algorithms stored thereon).

When ranges are used herein, combinations and subcombinations of ranges (including any value or subrange contained therein) are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A system for correcting a frequency response of at least one speaker as heard by an individual listener in a room, the system comprising:
a processor; and
a machine-readable medium in operable communication with the processor and having instructions stored thereon that, when executed by the processor, perform the following steps:
i) acquiring a measurement of a binaural room impulse response using an in-ear microphone to obtain two ipsilateral impulse responses comprising a left ipsilateral impulse responses for a left ear portion of the in-ear microphone and a right ipsilateral impulse response for a right ear portion of the in-ear microphone;
ii) limiting the two ipsilateral impulse responses with a first time window that is configured to include effects of sound reflections that need to be reflected, give two windowed impulse responses;
iii) extracting a direct part of the two windowed impulse responses using a second time window with a length that is configured to include a direct sound, to give two direct part impulse responses;
iv) calculating a frequency response corresponding to each of the two direct part impulse responses by taking their respective Fourier transforms, to give two intermediate frequency responses comprising a first intermediate frequency response and a second intermediate frequency response;
v) constructing a composite spectrum with a low-frequency part from the first intermediate frequency response and a high-frequency part from the second intermediate frequency response, to give two composite intermediate frequency responses comprising a first composite intermediate frequency response and a second composite intermediate frequency response, wherein the low-frequency part is less than a cutoff frequency and the high-frequency part is greater than or equal to the cutoff frequency;
vi) applying diffuse field equalization (DFEq) to the two composite intermediate frequency responses;
vii-a) locating a first pinna notch that is a frequency of a first main notch in the first composite intermediate frequency response that is a range of from 5 kilohertz (kHz) to 10 kHz;
vii-b) locating a second pinna notch that is a frequency of a first main notch in the second composite intermediate frequency response that is a range of from 5 kHz to 10 kHz;
viii-a) splitting the first composite intermediate frequency response into a first quasi-free field band, a first low-order pinna band, and a first high-order pinna band, wherein the first quasi-free field band is between a first predetermined low limit frequency and a first predetermined middle limit frequency that is higher than the first predetermined low limit frequency and lower than the first pinna notch, wherein the first low-order pinna band is between the first predetermined middle limit frequency and the first pinna notch, and wherein the first high-order pinna band is between the first pinna notch and a first predetermined high limit frequency that is higher than the first pinna notch;
viii-b) splitting the second composite intermediate frequency response into a second quasi-free field band, a second low-order pinna band, and a second high-order pinna band, wherein the second quasi-free field band is between a second predetermined low limit frequency and a second predetermined middle limit frequency that is higher than the second predetermined low limit frequency and lower than the second pinna notch, wherein the second low-order pinna band is between the second predetermined middle limit frequency and the second pinna notch, and wherein the second high-order pinna band is between the second pinna notch and a second predetermined high limit frequency that is higher than the second pinna notch;
ix) determining a measure of the spectral entropy for each of the first quasi-free field band, the first low-order pinna band, the first high-order pinna band, the second quasi-free field band, the second low-order pinna band, and the second high-order pinna band, to give a first quasi-free field spectral entropy measure, a first low-order pinna spectral entropy measure, a first high-order pinna spectral entropy measure, a second quasi-free field spectral entropy measure, a second low-order pinna spectral entropy measure, and a second high-order pinna spectral entropy measure;
x-a) making three copies of the first composite intermediate frequency response, and using a complex spectral smoothing method to smooth each of the three copies of the first composite intermediate frequency response, to give three first smoothed spectra respectively corresponding to the three copies of the first composite intermediate frequency response;
x-b) making three copies of the second composite intermediate frequency response, and using the complex spectral smoothing method to smooth each of the three copies of the second composite intermediate frequency response, to give three second smoothed spectra respectively corresponding to the three copies of the second composite intermediate frequency response;
xi) inverting each of the three first smoothed spectra and the three second smoothed spectra, to give three inverted first spectra and three inverted second spectra respectively corresponding to the three first smoothed spectra and the three second smoothed spectra;
xii-a) constructing a final first composite spectrum by smoothly joining a first segment, a second segment, and a third segment respectively taken from the three inverted first spectra;
xii-b) constructing a final second composite spectrum by smoothly joining a fourth segment, a fifth segment, and a sixth segment respectively taken from the three inverted second spectra; and
xiii) deriving a finite response filter from the final first composite spectrum and the final second composite spectrum, wherein the finite response filter is configured to be convolved with input audio of the at least one speaker to correct the frequency response of the at least one speaker.

2. The system according to claim 1, wherein the three copies of the first composite intermediate frequency response comprise a first quasi-free field composite intermediate frequency response, a first low-order pinna composite intermediate frequency response, and a first high-order pinna composite intermediate frequency response,
wherein using the complex spectral smoothing method to smooth each of the three copies of the first composite intermediate frequency response in step x-a) comprises smoothing the first quasi-free field composite intermediate frequency response based on a first smoothing degree that is proportional to the first quasi-free field spectral entropy measure, smoothing the first low-order pinna composite intermediate frequency response based on a second smoothing degree that is proportional to the first low-order pinna spectral entropy measure, and smoothing the first high-order pinna composite intermediate frequency response based on a third smoothing degree that is proportional to the first high-order pinna spectral entropy measure,
wherein the three copies of the second composite intermediate frequency response comprise a second quasi-free field composite intermediate frequency response, a second low-order pinna composite intermediate frequency response, and a second high-order pinna composite intermediate frequency response, and
wherein using the complex spectral smoothing method to smooth each of the three copies of the second composite intermediate frequency response in step x-b) comprises smoothing the second quasi-free field composite intermediate frequency response based on a fourth smoothing degree that is proportional to the second quasi-free field spectral entropy measure, smoothing the second low-order pinna composite intermediate frequency response based on a fifth smoothing degree that is proportional to the second low-order pinna spectral entropy measure, and smoothing the second high-order pinna composite intermediate frequency response based on a sixth smoothing degree that is proportional to the second high-order pinna spectral entropy measure.

3. The system according to claim 2, wherein the three inverted first spectra comprise a first inverted quasi-free field spectrum, a first inverted low-order pinna spectrum, and a first inverted high-order pinna spectrum,
wherein the three inverted second spectra comprise a second inverted quasi-free field spectrum, a second inverted low-order pinna spectrum, and a second inverted high-order pinna spectrum,
wherein, in step xii-a), the first segment is taken from the first inverted quasi-free field spectrum between the first predetermined low limit frequency and the first predetermined middle limit frequency, the second segment is taken from the first inverted low-order pinna spectrum between the first predetermined middle limit frequency and the first pinna notch, and the third segment is taken from the first inverted high-order pinna spectrum between the first pinna notch and the first predetermined high limit frequency, and
wherein, in step xii-b), the fourth segment is taken from the second inverted quasi-free field spectrum between the second predetermined low limit frequency and the second predetermined middle limit frequency, the fifth segment is taken from the second inverted low-order pinna spectrum between the second predetermined middle limit frequency and the second pinna notch, and the sixth segment is taken from the second inverted high-order pinna spectrum between the second pinna notch and the second predetermined high limit frequency.

4. The system according to claim 1, wherein step ix) comprises using the Shannon entropy formula to determine the measure of the spectral entropy for each of the first quasi-free field band, the first low-order pinna band, the first high-order pinna band, the second quasi-free field band, the second low-order pinna band, and the second high-order pinna band.

5. The system according to claim 1, wherein step xiii) comprises:
using the Hilbert transform on the final first composite spectrum to calculate an imaginary part of a spectrum of a minimum phase filter whose real part is that of the final first composite spectrum, and then using the inverse Fourier transform to get a first finite impulse response (FIR) of the finite response filter; and
using the Hilbert transform on the final second composite spectrum to calculate an imaginary part of a spectrum of a minimum phase filter whose real part is that of the final second composite spectrum, and then using the inverse Fourier transform to get a second FIR of the finite response filter.

6. The system according to claim 1, wherein the first time window is at least 35 milliseconds (ms), and
wherein the second time window is at about 5 ms.

7. The system according to claim 1, wherein step i) comprises performing playback of exponential sine sweeps from the at least one speaker, recording sound at respective entrances of ear canals of the individual listener, and then using at least one deconvolution technique to deconvolve an impulse response of the sound in order to acquire the measurement of the binaural room impulse response.

8. The system according to claim 1, wherein the first predetermined low limit frequency and the second predetermined low limit frequency are both below 100 Hertz (Hz), and
wherein the first predetermined middle limit frequency and the second predetermined middle limit frequency are both in a range of from 700 Hz to 1000 Hz.

9. The system according to claim 1, wherein step vi) comprises multiplying each of the two composite intermediate frequency responses by an inverse diffuse field response obtained by averaging at least 30 measurements on human heads.

10. The system according to claim 1, wherein the instructions when executed further perform the following step:
xiv) providing the finite response filter to a source of the input audio of the at least one speaker such that the finite response filter is convolved with the input audio, thereby correcting the frequency response of the at least one speaker.

11. A method for correcting a frequency response of at least one speaker as heard by an individual listener in a room, the method comprising:
i) acquiring a measurement of a binaural room impulse response using an in-ear microphone to obtain two ipsilateral impulse responses comprising a left ipsilateral impulse responses for a left ear portion of the in-ear microphone and a right ipsilateral impulse response for a right ear portion of the in-ear microphone;
ii) limiting the two ipsilateral impulse responses with a first time window that is configured to include effects of sound reflections that need to be reflected, give two windowed impulse responses;
iii) extracting a direct part of the two windowed impulse responses using a second time window with a length that is configured to include a direct sound, to give two direct part impulse responses;
iv) calculating a frequency response corresponding to each of the two direct part impulse responses by taking their respective Fourier transforms, to give two intermediate frequency responses comprising a first intermediate frequency response and a second intermediate frequency response;
v) constructing a composite spectrum with a low-frequency part from the first intermediate frequency response and a high-frequency part from the second intermediate frequency response, to give two composite intermediate frequency responses comprising a first composite intermediate frequency response and a second composite intermediate frequency response, wherein the low-frequency part is less than a cutoff frequency and the high-frequency part is greater than or equal to the cutoff frequency;
vi) applying diffuse field equalization (DFEq) to the two composite intermediate frequency responses;
vii-a) locating a first pinna notch that is a frequency of a first main notch in the first composite intermediate frequency response that is a range of from 5 kilohertz (kHz) to 10 kHz;
vii-b) locating a second pinna notch that is a frequency of a first main notch in the second composite intermediate frequency response that is a range of from 5 kHz to 10 kHz;
viii-a) splitting the first composite intermediate frequency response into a first quasi-free field band, a first low-order pinna band, and a first high-order pinna band, wherein the first quasi-free field band is between a first predetermined low limit frequency and a first predetermined middle limit frequency that is higher than the first predetermined low limit frequency and lower than the first pinna notch, wherein the first low-order pinna band is between the first predetermined middle limit frequency and the first pinna notch, and wherein the first high-order pinna band is between the first pinna notch and a first predetermined high limit frequency that is higher than the first pinna notch;
viii-b) splitting the second composite intermediate frequency response into a second quasi-free field band, a second low-order pinna band, and a second high-order pinna band, wherein the second quasi-free field band is between a second predetermined low limit frequency and a second predetermined middle limit frequency that is higher than the second predetermined low limit frequency and lower than the second pinna notch, wherein the second low-order pinna band is between the second predetermined middle limit frequency and the second pinna notch, and wherein the second high-order pinna band is between the second pinna notch and a second predetermined high limit frequency that is higher than the second pinna notch;
ix) determining a measure of the spectral entropy for each of the first quasi-free field band, the first low-order pinna band, the first high-order pinna band, the second quasi-free field band, the second low-order pinna band, and the second high-order pinna band, to give a first quasi-free field spectral entropy measure, a first low-order pinna spectral entropy measure, a first high-order pinna spectral entropy measure, a second quasi-free field spectral entropy measure, a second low-order pinna spectral entropy measure, and a second high-order pinna spectral entropy measure;
x-a) making three copies of the first composite intermediate frequency response, and using a complex spectral smoothing method to smooth each of the three copies of the first composite intermediate frequency response, to give three first smoothed spectra respectively corresponding to the three copies of the first composite intermediate frequency response;
x-b) making three copies of the second composite intermediate frequency response, and using the complex spectral smoothing method to smooth each of the three copies of the second composite intermediate frequency response, to give three second smoothed spectra respectively corresponding to the three copies of the second composite intermediate frequency response;
xi) inverting each of the three first smoothed spectra and the three second smoothed spectra, to give three inverted first spectra and three inverted second spectra respectively corresponding to the three first smoothed spectra and the three second smoothed spectra;
xii-a) constructing a final first composite spectrum by smoothly joining a first segment, a second segment, and a third segment respectively taken from the three inverted first spectra;
xii-b) constructing a final second composite spectrum by smoothly joining a fourth segment, a fifth segment, and a sixth segment respectively taken from the three inverted second spectra; and
xiii) deriving a finite response filter from the final first composite spectrum and the final second composite spectrum, wherein the finite response filter is configured to be convolved with input audio of the at least one speaker to correct the frequency response of the at least one speaker.

12. The method according to claim 11, wherein the three copies of the first composite intermediate frequency response comprise a first quasi-free field composite intermediate frequency response, a first low-order pinna composite intermediate frequency response, and a first high-order pinna composite intermediate frequency response,
wherein using the complex spectral smoothing method to smooth each of the three copies of the first composite intermediate frequency response in step x-a) comprises smoothing the first quasi-free field composite intermediate frequency response based on a first smoothing degree that is proportional to the first quasi-free field spectral entropy measure, smoothing the first low-order pinna composite intermediate frequency response based on a second smoothing degree that is proportional to the first low-order pinna spectral entropy measure, and smoothing the first high-order pinna composite intermediate frequency response based on a third smoothing degree that is proportional to the first high-order pinna spectral entropy measure,
wherein the three copies of the second composite intermediate frequency response comprise a second quasi-free field composite intermediate frequency response, a second low-order pinna composite intermediate frequency response, and a second high-order pinna composite intermediate frequency response, and
wherein using the complex spectral smoothing method to smooth each of the three copies of the second composite intermediate frequency response in step x-b) comprises smoothing the second quasi-free field composite intermediate frequency response based on a fourth smoothing degree that is proportional to the second quasi-free field spectral entropy measure, smoothing the second low-order pinna composite intermediate frequency response based on a fifth smoothing degree that is proportional to the second low-order pinna spectral entropy measure, and smoothing the second high-order pinna composite intermediate frequency response based on a sixth smoothing degree that is proportional to the second high-order pinna spectral entropy measure.

13. The method according to claim 12, wherein the three inverted first spectra comprise a first inverted quasi-free field spectrum, a first inverted low-order pinna spectrum, and a first inverted high-order pinna spectrum,
wherein the three inverted second spectra comprise a second inverted quasi-free field spectrum, a second inverted low-order pinna spectrum, and a second inverted high-order pinna spectrum,
wherein, in step xii-a), the first segment is taken from the first inverted quasi-free field spectrum between the first predetermined low limit frequency and the first predetermined middle limit frequency, the second segment is taken from the first inverted low-order pinna spectrum between the first predetermined middle limit frequency and the first pinna notch, and the third segment is taken from the first inverted high-order pinna spectrum between the first pinna notch and the first predetermined high limit frequency, and
wherein, in step xii-b), the fourth segment is taken from the second inverted quasi-free field spectrum between the second predetermined low limit frequency and the second predetermined middle limit frequency, the fifth segment is taken from the second inverted low-order pinna spectrum between the second predetermined middle limit frequency and the second pinna notch, and the sixth segment is taken from the second inverted high-order pinna spectrum between the second pinna notch and the second predetermined high limit frequency.

14. The method according to claim 11, wherein step ix) comprises using the Shannon entropy formula to determine the measure of the spectral entropy for each of the first quasi-free field band, the first low-order pinna band, the first high-order pinna band, the second quasi-free field band, the second low-order pinna band, and the second high-order pinna band.

15. The method according to claim 11, wherein step xiii) comprises:
using the Hilbert transform on the final first composite spectrum to calculate an imaginary part of a spectrum of a minimum phase filter whose real part is that of the final first composite spectrum, and then using the inverse Fourier transform to get a first finite impulse response (FIR) of the finite response filter; and
using the Hilbert transform on the final second composite spectrum to calculate an imaginary part of a spectrum of a minimum phase filter whose real part is that of the final second composite spectrum, and then using the inverse Fourier transform to get a second FIR of the finite response filter.

16. The method according to claim 11, wherein the first time window is at least 35 milliseconds (ms), and
wherein the second time window is at about 5 ms.

17. The method according to claim 11, wherein step i) comprises performing playback of exponential sine sweeps from the at least one speaker, recording sound at respective entrances of ear canals of the individual listener, and then using at least one deconvolution technique to deconvolve an impulse response of the sound in order to acquire the measurement of the binaural room impulse response.

18. The method according to claim 11, wherein the first predetermined low limit frequency and the second predetermined low limit frequency are both below 100 Hertz (Hz), and
wherein the first predetermined middle limit frequency and the second predetermined middle limit frequency are both in a range of from 700 Hz to 1000 Hz.

19. The method according to claim 11, wherein step vi) comprises multiplying each of the two composite intermediate frequency responses by an inverse diffuse field response obtained by averaging at least 30 measurements on human heads.

20. The method according to claim 11, further comprising:
xiv) providing the finite response filter to a source of the input audio of the at least one speaker such that the finite response filter is convolved with the input audio, thereby correcting the frequency response of the at least one speaker.
